(19) United States
(12) Patent Application Publication
(10) Pub. No.: US 2026/0216669 A1
(43) Pub. Date: Jul. 30, 2026

(54) OXIDATION RESISTANT MEMBRANES

(71) Applicant: BASF SE, Ludwigshafen am Rhein (DE)

(72) Inventors: Oliver GRONWALD, Ludwigshafen am Rhein (DE); Martin WEBER, Ludwigshafen am Rhein (DE)

(21) Appl. No.: 19/141,235

(22) PCT Filed: Dec. 15, 2023
(86) PCT No.: PCT/EP2023/086176

§ 371 Date: Jun. 19, 2025

(30) Foreign Application Priority Data
Dec. 21, 2022 (EP) 22215711.7

(51) Int. Cl. B01D 71/52; B01D 61/14; B01D 67/00; B01D 69/02; B01D 69/06; B01D 69/08; C08G 65/40

(52) U.S. Cl. CPC B01D 71/5223; B01D 67/0011; B01D 67/003; B01D 69/02; B01D 69/06; B01D 69/08; C08G 65/40; B01D 61/145; B01D 2325/022; B01D 2325/30

(57) ABSTRACT

The present invention relates to an oxidation resistant membrane comprising a poly(arylene ether nitrile) polymer (P), to its preparation and uses.

The present invention relates to a membrane comprising a poly(arylene ether nitrile) polymer (P) having structural units of formula (I) and (II), or (I) and (III), or (I), (II) and (III), to a method for the preparation of the membrane and to the use of the membrane e.g. for drinking water purification or other water treatments. In particular, the present invention relates to a an ultrafiltration membrane comprising a poly(arylene ether nitrile) polymer (P) having structural units of formula (I) and (II), or (I) and (III), or (I), (II) and (III), its preparation and uses.

To be suitable in membrane applications, polymeric materials need to exhibit particular mechanical properties, thermal stability and chemical resistance. Polyarylene sulfones are commonly used as membrane materials due to their high heat resistance and good mechanical properties (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190). For example, they are suitable as material for forming dialysis membranes (N. A. Hoenich, K. P. Katapodis, Biomaterials 23 (2002) 3853) and ultrafiltration (UF) membranes. Blends of polyethersulfone (PES) and polyvinylpyrrolidone (PVP) are used in membranes for water filtration. Ageing of PES/PVP ultrafiltration membranes due to the cleaning of the membranes with chemicals such as bleach has been described (R. Prulho et al., Polymer Degradation and Stability 98 (2013) 1164-1172). One problem connected with ultrafiltration membranes is membrane fouling leading to undesirable decay in membrane performance, making membrane cleaning steps necessary and leading to shortening of membrane lifespan. Membrane fouling studies using ultrafiltration membranes made from polyethersulfone (PESU) and new polyphenylene sulfone (PPSU) based membranes are reported in A. K. Shalmani et al. (Separation and Purification Technology 251 (2020), 117345).

Biphenyl-based poly(arylene ether nitrile) polymer (P) copolymers in general are known. X. B. Liu et al. (eXPRESS Polymer Letters Vol. 1, No. 8 (2007), 499-505) report the synthesis, characterization and rheological properties of biphenyl-based poly(arylene ether nitrile) polymer (P) copolymers.

A poly(arylene ether nitrile) polymer (P) PEN, that is made from bisphenol A and benzonitrile units, has been discussed as membrane material in Qi Wang et al. (Water Science & Technology, Nov. 5, 2020 (https://doi.org/10.2166/wst.2020.529)). Qi Wang et al. report about the fabrication of flat sheet ultrafiltration membranes using poly(arylene ether nitrile) polymer (P) (PEN) with poly(ethylene glycol) as additive via non-solvent induced phase separation.

US 2011/0168631 A1 is directed to methods and apparatuses for water filtration using polyarylether copolymer membranes, wherein the polymer material contains benzonitrile structural units. The material used in reverse osmosis membranes and ultrafiltration membranes also contains polyarylene sulfone structural units and/or structural units derived from bisphenol A. Zhang et al. (High Performance Polymers 2019, Vol 31 (8) 977-985) discuss a poly(arylene ether nitrile) polymer (P) (PEN) ultrafiltration membrane based on bisphenol A and benzonitrile units for water purification and its antifouling property using in-situ-generated SiO₂ nanoparticles.

The fouling of membrane material is a problem. Consequently, membranes that are used for example for water purification need to be able to be cleaned by hydraulic backwashing and chemical cleaning in-place (CIP) process in order to restore their filtration performance. The CIP is usually carried out with aqueous acids and bases and oxidative chemicals such as NaOCl to remove fouling and other residues.

For profitability reasons as well as from an environmental standpoint, there is a need for membranes that can be operated as long as possible. Consequently, the membrane material has to be resistant against common cleaning methods and chemicals, in particular oxidative conditions, as there is need for membranes that can be properly cleaned several times without significant change in performance. Furthermore, it may be desired to replace polymer material using bisphenol A or bisphenol S structural units.

There is need for a membrane exhibiting an excellent selectivity and high membrane productivity as well as good mechanical properties. Specifically, there is need for ultrafiltration membranes having low molecular weight cut-off and high water permeation rate at the same time. Furthermore, said membrane should be easy and practical to clean to remove impurities and residues thereby avoiding degradation of the membrane material and maintaining its performance. The method for the preparation of the membrane should be easy to perform at relatively low costs. This object is achieved by a membrane (M) comprising a poly(arylene ether nitrile) polymer (P) having structural units of formula (I) and (II); (I) and (III), or (I), (II) and (III) as described herein. It has surprisingly been found that the poly(arylene ether nitrile) polymer (P) used according to the present invention is particularly suitable as material for membranes, in particular for ultrafiltration membranes. Consequently, the present invention provides an efficient membrane, its preparation and uses. The membranes according to the invention show excellent selectivity and efficiency and, at the same time, are easy to clean with surprising maintenance of membrane performance.

The inventive membrane comprises a poly(arylene ether nitrile) polymer (P) comprising structural units of formula (I) and (II); (I) and (III), or (I), (II) and (III):

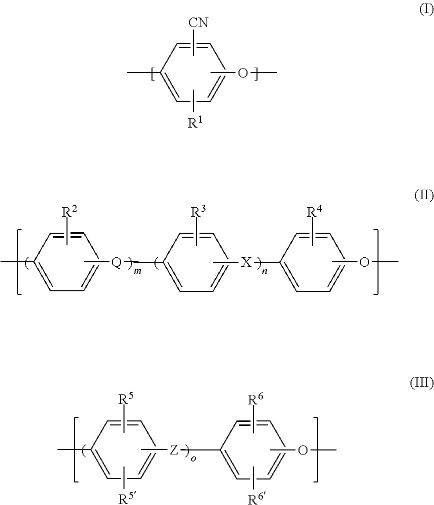

wherein
Q is a direct bond or O;
X is a direct bond or O;
Z is a direct bond or O;
R¹, R², R³, R⁴, R⁵, R^{5′}, R⁶ and R^{6′} are independently selected from H, halogen, nitro and OR, wherein R is independently selected from C₁-C₆ alkyl and C₆-C₁₂ aryl; and m, n and o are independently selected from 0 or 1.

In the present invention, the variables are defined and preferably defined as outlined herein, wherein their definitions and preferred definitions independently apply to each of the embodiments described herein. Further, each of the preferred definitions can be combined with any of the definitions and preferred definitions of any other variable.

R¹, R², R³, R⁴, R⁵, R^{5′}, R⁶ and R^{6′} are independently selected from H, halogen, nitro and OR, wherein R is independently selected from C₁-C₆ alkyl and C₆-C₁₂ aryl.

Halogen is selected from F, Cl, Br and I, more specifically from F, CI and Br, particularly F or Cl.

C₁-C₆-alkyl groups comprise linear and branched, saturated alkyl groups having from 1 to 6 carbon atoms, such as in particular C₁-C₄-alkyl and C₁-C₃-alkyl. Particular examples are methyl, ethyl, n-propyl, i-propyl, n-butyl, sec-butyl, 2- or 3-methylpentyl.

C₆-C₁₂-arylene groups include unsubstituted and substituted phenyl and unsubstituted and substituted naphthyl.

In OR, R is selected from C₁-C₆-alkyl and C₆-C₁₂-aryl, preferably R is C₁-C₆-alkyl, more preferably R is C₁-C₄-alkyl, particularly methyl or ethyl, more specifically methyl.

Preferably, R¹, R², R³, R⁴, R⁵, R^{5′}, R⁶ and R^{6′}, if present at all, are independently selected from H, F, Cl, nitro and OCH₃, more specifically independently selected from H, F, Cl, Br and OCH₃. In particular, R¹, R², R³, R⁴, R⁵, R^{5′}, R⁶ and R^{6′}, if present at all, are independently selected from H, F and Cl. The skilled person will understand that if any one of m, n and o is 0, the respective substituent(s) R², R³, R⁵ or R^{5′}, respectively, in the respective phenyl group(s) is/are not present and its/their definition(s) become/s moot.

Q is preferably a direct bond. X is preferably a direct bond. Y is preferably a direct bond.

According to one embodiment, m is 0. According to a further embodiment, m is 1. According to one embodiment, n is 0. According to a further embodiment, n is 1. According to one embodiment, o is 0. According to a further embodiment, o is 1.

According to one embodiment, in the structural unit of Formula (I), in particular in sub-Formula (I-6) below, R¹ is selected from F, Cl, Br and OCH₃, more specifically F, CI and Br. Particularly, R¹ in formula (I-6) is in 4- or in 6-position (as indicated by the number “4” and “6”, respectively, in formula (I-6)). One specific embodiment of (1-6) is 4-Br- or 6-Br-substituted, respectively.

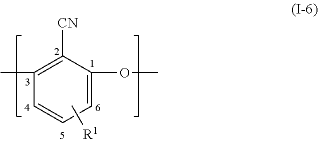

According to a preferred embodiment, in the structural unit of Formula (I), R¹ is H. According to a further embodiment, the oxy (—O—) group is in meta position to the chemical bond connecting to the adjacent structural unit. In a further embodiment, the cyano group is in ortho position to the oxy group and in ortho position to the chemical bond.

One inventive embodiment relates to sub-Formula (I-1). A further embodiment relates to subformula (I-2). Still a further embodiment of the invention relates to sub-Formula (1-3):

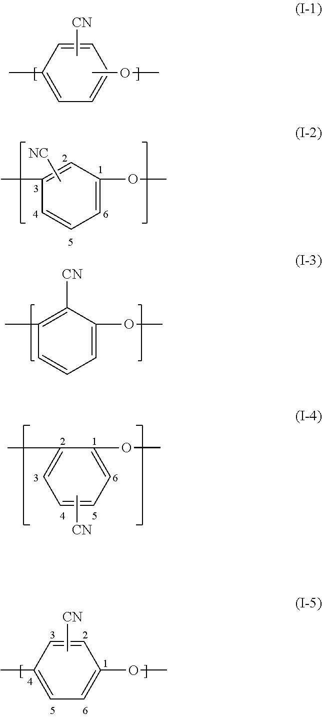

In the embodiment of structural unit (I-2), the cyano group is particularly preferably in 2-position (as indicated by the number “2” in formula (I-2)), namely structural unit (I-3). In a further embodiment thereof, the cyano group is in 4- or 6-position (as indicated by the numbers “4” and “6”, respectively, in formula (I-2)). In still a further embodiment thereof, the cyano group is in 5-position (as indicated by the number “5” in formula (I-2)).

In the embodiment of structural unit (I-4), the cyano group is particularly preferably in 3- or 6-position (as indicated by the numbers “3” and “6”, respectively, in formula (I-4)).

In the embodiment of structural unit (I-5), the cyano group is in either of positions 2,3,5 or 6.

According to one embodiment, in the structural unit of Formula (II), R² is selected from F, CI and OCH₃. According to a further embodiment, in Formula (II), R² is H. According to a further embodiment, in the structural unit of Formula (II), R³ is selected from F, CI and OCH₃. According to still a further embodiment, in Formula (II), R³ is H. According to a further embodiment, in the structural unit of Formula (II), R⁴ is selected from F, CI and OCH₃. According to a further embodiment, in Formula (II), R⁴ is H.

In one particular embodiment of the structural unit of Formula (II), R², R³ and R⁴ are H, corresponding to the inventive embodiment of sub-Formula (II-1).

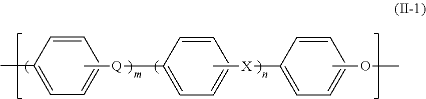

According to a further embodiment, the bonds connecting the phenyl groups in Formula (II) are all in para position to each other, corresponding to the inventive embodiment of sub-Formula (II-2) and, more specifically sub-Formula (II-3):

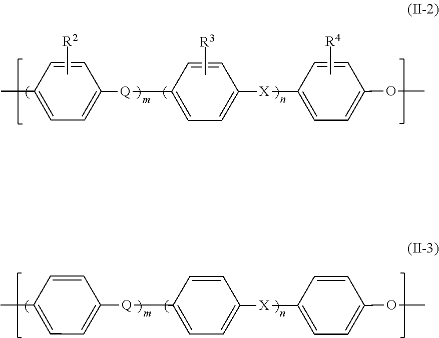

In formula (II) and preferred embodiments of formula (II), substituent m is 0 or 1, preferably 0. Substituent n is 0 or 1, preferably 1. Consequently, further preferred sub-formulae of (II) are (II-4), (II-5), (II-6) and (II-7):

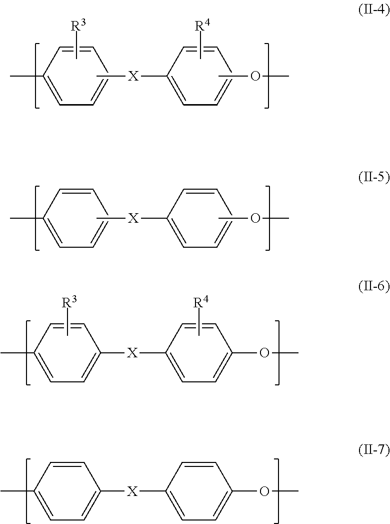

In formula (II) or preferred sub-formulae of (II), Q is selected from a direct bond, O and S, preferably, Q is a direct bond or O. X is selected from a direct bond, O and S, preferably, X is a direct bond or O, more specifically, X is a direct bond. The skilled person will understand that if m is 0, the definition of Q becomes moot, and if n is 0, the definition of X becomes moot.

According to one particular embodiment of Formula (II), m is 0, n is 1 and X is a direct bond. More specifically, the phenyl rings are para to each other. Even more specifically, in this embodiment, R², R³ and R⁴ are all H, the formula being represented by sub-Formula (II-8)

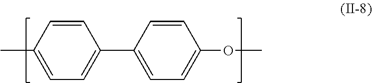

According to one embodiment, in the structural unit of Formula (III), R⁵ is selected from F, CI and OCH₃. According to a further embodiment, in Formula (III), R⁵ is H. According to a further embodiment, in the structural unit of Formula (III), R^{5′} is selected from F, CI and OCH₃. According to still a further embodiment, in Formula (III), R^{5′} is H. According to a further embodiment, in the structural unit of Formula (III), R⁶ is selected from F, CI and OCH₃. According to still a further embodiment, in Formula (II), R⁶ is H. According to a further embodiment, in the structural unit of Formula (III), R^{6′} is selected from F, CI and OCH₃. According to still a further embodiment, in Formula (III), R^{6′} is H.

In one particular embodiment of the invention, in the structural unit of Formula (III), R⁵, R^{5′} and R^{6′} are H, corresponding to sub-Formula (III-1). Another embodiment, wherein R⁵, R^{5′}, R⁶ and R^{6′} are all H, corresponds to sub-Formula (III-2). Variable o is 0 or 1:

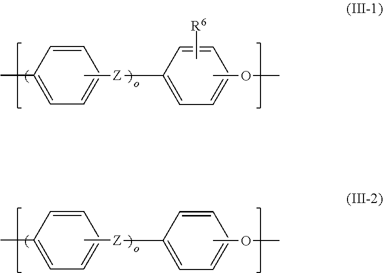

In further embodiments, substituent o is 0 and R⁵ and R^{5′} are H; R⁵, R^{5′} and R^{6′} are H; or R⁵, R^{5′}, R⁶ and R^{6′} are H, respectively, corresponding to sub-Formulae (III-3a), (III-3) and (III-4), respectively:

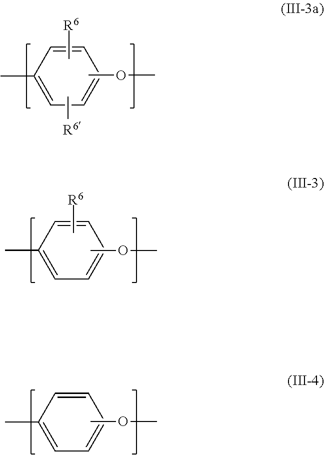

In sub-Formula (III-3a), the —O-bond is preferably in para position to the chemical bond to the adjacent structural unit and R⁶ and R^{6′} are independently selected from F, CI and OCH₃. In one further embodiment, the —O-bond is in para position to the chemical bond to the adjacent structural unit. More specifically, in this embodiment R⁵, R^{5′} and R^{6′} are H in this embodiment, more preferably, R⁵, R^{5′}, R⁶ and R^{6′} are H, corresponding to the inventive embodiments of sub-Formulae (III-5) and (III-6). Even more specifically, in this embodiment, o is 0 (sub-Formula (III-7) and (III-8), respectively:

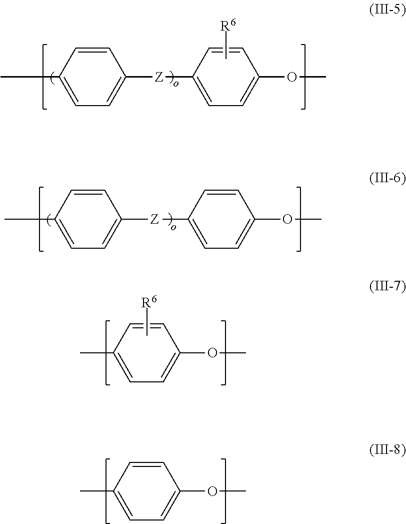

The inventive membrane (M) comprises a poly(arylene ether nitrile) polymer (P) having structural units of Formula (I) and (II), (I) and (III), or (I), (II) and (III) as defined and preferably defined above.

According to one embodiment, the poly(arylene ether nitrile) polymer (P) comprises structural units of (I) and (II), as defined and preferably defined above. In one particular embodiment, the poly(arylene ether nitrile) polymer (P) is essentially consisting of structural units of (I) and (II), as defined and preferably defined above. Is “essentially consisting of” means that the poly(arylene ether nitrile) polymer (P) comprises more than 95%, preferably more than 97% and most preferably more than 98% of structural units (I) and (II) based on the total amount of structural units in the polymer (P).

One embodiment thereof (where m=0 and n=1 in the unit derived from Formula (II), see sub-Formula (II-4)) is represented by sub-Formula (IV).

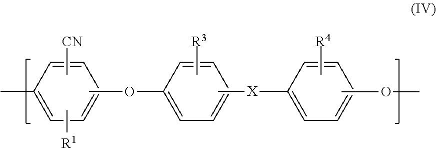

X, R¹, R³ and R⁴ are as defined and preferably defined herein. In one particularly preferred embodiment, X is a direct bond.

A further embodiment (where m=0, n=1 and R¹═R³═R⁴═H) is represented by sub-Formula (IV-1).

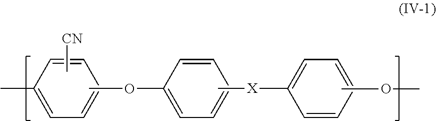

In still a further embodiment thereof, X is a direct bond, the CN-group is in ortho position to the oxy group and in ortho position to the chemical bond and the direct bond in the biphenyl is para to both oxy groups (sub-Formula (IV-2)):

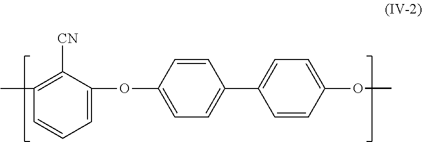

According to a further embodiment, the poly(arylene ether nitrile) polymer (P) comprises structural units of (I) and (III), as defined and preferably defined above. In one particular embodiment, the poly(arylene ether nitrile) polymer (P) is essentially consisting of structural units of (I) and (III), as defined and preferably defined above. Is “essentially consisting of” means that the poly(arylene ether nitrile) polymer (P) comprises more than 95%, preferably more than 97% and most preferably more than 98% of structural units (I) and (III) based on the total amount of structural units in the polymer (P).

One embodiment thereof (where o=0 and R^{6′} is H in the unit derived from Formula (III)) is represented by sub-Formula (V). A further embodiment thereof (where o=0, R¹═R^{6′}═R⁶═H) is represented by sub-Formula (V-1). Still a further embodiment thereof, where o=0, R¹═R^{6′}═R⁶═H, the CN-group is in ortho position to the oxy group and in ortho position to the chemical bond and the oxy groups are in para position to each other, is represented by sub-Formula (V-2):

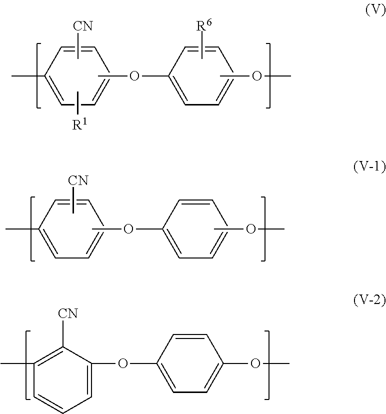

In (V), R¹ and R⁶ are as defined and preferably defined herein.

According to still a further embodiment of the present invention the poly(arylene ether nitrile) polymer (P) contains structural units of Formula (I), (II) and (III) as defined and preferably defined above. In one particular embodiment, the poly(arylene ether nitrile) polymer (P) is essentially consisting of structural units of (I), (II) and (III), as defined and preferably defined above. Is “essentially consisting of” means that the poly(arylene ether nitrile) polymer (P) comprises more than 95%, preferably more than 97% and most preferably more than 98% of structural units (I), (II) and (III) based on the total amount of structural units in the polymer (P).

In one preferred embodiment, the poly(arylene ether nitrile) polymer (P) contains structural units of Formulae (I), (II-4) and (III-3) as defined and preferably defined above.

A preferred building block in the poly(arylene ether nitrile) polymer (P) is structural unit (VI):

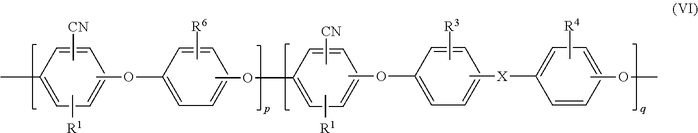

In unit (VI), R¹, R³, R⁴, R⁶ and X are as defined and preferably defined herein. The variables p and q are each from 0.05 to 0.95. It may be preferred, if p is from 0.05 to 0.4 and q is from 0.95 to 0.6, more specifically it may be preferred if p is from 0.1 to 0.3 and q is from 0.9 to 0.7. In one embodiment thereof, R¹ is H, being represented by sub-Formula (VI-1), wherein R³, R⁴, R⁶ and X are as defined and preferably defined herein and wherein the variables q and p are each from 0.05 to 0.95 or as preferably defined above. Preferably, X is a direct bond:

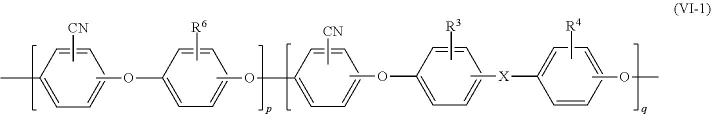

According to a further embodiment, R¹ is H, the CN-group is in ortho position to the oxy group and in ortho position to the chemical bond, the oxy groups are in para position to each other, X is a direct bond and the two phenyl groups of the biphenyl unit are in para position to the oxy groups, represented by sub-Formula (VI-2):

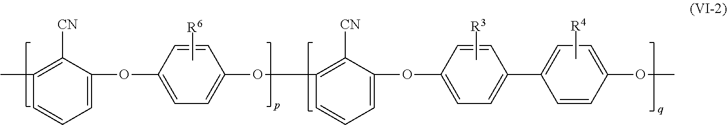

In particular, therein, R³, R⁴ and R⁶ are H (sub-Formula (VI-3):

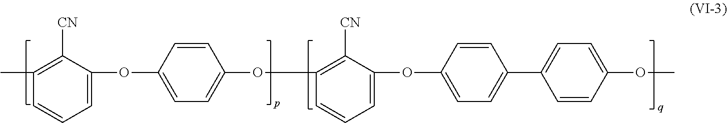

The poly(arylene ether nitrile) polymer (P) as defined and preferably defined herein does not contain structural units that are derived from bisphenol A or bisphenol S, and, consequently, does not contain sulfone (SO₂) groups or C(CH₃)₂ bridges in its structure.

At least part of the poly(arylene ether nitrile) polymer (P)s disclosed and described herein are novel. Consequently, one object of the present invention is the novel poly(arylene ether nitrile) polymer (P)s.

The poly(arylene ether nitrile) polymer (P) as defined and preferably defined herein has a glass transition temperature (DSC, 20 K/min; according to ISO 11357-1 (2017) and 11357-2 (2020)) of typically 180 to 220° C.

Unless otherwise stated, preparation of the poly(arylene ether nitrile) polymer (P) polymers (P) is generally performed by applying standard methods of polymer technology. In general, the reagents and monomeric constituents as used herein are either commercially available or well-known from the prior art or easily accessible to a skilled person via disclosure of the prior art. For example, the synthesis of the poly(arylene ether nitrile) polymer (P) can be carried out by reacting at least one dihalobenzonitrile with at least one aromatic dihydroxy compound in a polar aprotic solvent such as, for example N-methylpyrrolidone (NMP), in the presence of a metal carbonate.

The reaction may follow or be in analogy to scheme 1 (exemplary for reacting educts with structural units (I), (II) and (III)):

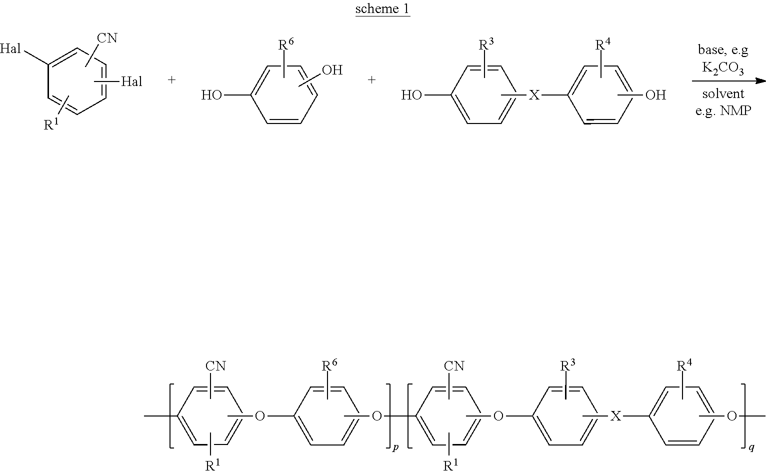

Consequently, suitable educts to introduce structural units (I) are dihalobenzonitriles, that can be further substituted (by R¹ as defined above) or not. For example, 2,6-dichlorobenzonitrile, 2,6-difluorobenzonitrile, 2,5-dichlorobenzonitrile, 2,5-dichlorobenzonitrile, 2,5-difluorobenzonitrile, 2,4-dichlorobenzonitrile, 3,5-dichlorobenzonitrile, 2,3-dichlorobenzonitrile and 3-bromo-2,6-difluorobenzonitrile can suitably be used.

For structural units (II), suitable educts are dihydroxy aryl compounds, such as, for example unsubstituted or substituted (as defined above) 4-(4-hydroxyphenyl) phenol.

Structural units (III) may be derived from, for example, dihydroxyphenyl, that can be further substituted or not. Examples are 1,4-dihydroxy phenyl (hydroquinone), 1,3-dihydroxy phenyl (resorcine) and 1,2-dihydroxy phenyl (brenzcatechin), in each case with no further substituents or substituted as defined herein. Examples for substituted dihydroxyphenyl are 2-methoxybenzene-1,4-diol, 2,6-dimethoxybenzene-1,4-diol.

The process for the synthesis of the poly(arylene ether nitrile) polymer (P) (P) is carried out in the presence of a metal carbonate, in particular an anhydrous metal carbonate. It is possible to use one sort of metal carbonate, but also mixtures of two or more metal carbonates may be used, preferably the metal carbonate (or the preferred metal carbonate as given below) used is anhydrous.

Preference is given to alkali metal carbonates and/or alkaline earth metal carbonates as metal carbonates. At least one metal carbonate selected from the group consisting of sodium carbonate, potassium carbonate and calcium carbonate or mixtures thereof is particularly preferred as metal carbonate. Potassium carbonate, in particular anhydrous, is most preferred.

Potassium carbonate having a volume weighted average particle size of less than 200 μm is particularly preferred as potassium carbonate. The volume weighted average particle size of the potassium carbonate is determined in a suspension of potassium carbonate in N-methylpyrrolidone using a particle size analyzer.

The metal carbonate typically used in an excess amount in relation to the dihydroxy component, such as in excess of at least 3 mol %, preferably at least 4 mol %. It may be advantageous, if an excess of at least 5 mol % is used.

At least one aprotic polar solvent is used in the synthesis of the poly(arylene ether nitrile) polymer (P). This may be exactly one aprotic polar solvent and mixtures of two or more aprotic polar solvents. Suitable aprotic polar solvents are, for example, selected from the group consisting of anisole, dimethylformamide, dimethylsulfoxide, sulfolane, N-methylpyrrolidone, N-ethylpyrrolidone and N-dimethylacetamide. Preferably, a suitable solvent is selected from the group consisting of N-methylpyrrolidone, N-dimethylacetamide, dimethylsulfoxide and dimethylformamide. N-methylpyrrolidone is particularly preferred.

For example, the solvent may comprise at least 50% by weight of at least one solvent selected from group consisting of N-methylpyrrolidone, N-dimethylacetamide, dimethylsulfoxide and dimethylformamide based on the total weight of the solvent used. N-methylpyrrolidone is particularly preferred. More specifically, the polar aprotic solvent used may consist essentially of N-methylpyrrolidone, meaning that the solvent comprises more than 98% by weight, particularly preferably more than 99% by weight, more preferably more than 99.5% by weight, N-methylpyrrolidone. It may be suitable if the polar aprotic solvent of N-methylpyrrolidone. N-methylpyrrolidone is also referred to as NMP or N-methyl-2-pyrrolidone.

A particularly suitable combination is N-methyl-2-pyrrolidone as polar aprotic solvent and potassium carbonate as the metal carbonate base.

The reaction may be carried out at a temperature from about 100° C. to about 300° C., specifically from 120° C. to 200° C., such as 150° C. to 200° C.

The poly(arylene ether nitrile) polymer (P) preferably has a number-average molecular weight (M_{N}) of from 10 000 to 40 000 g/mol, determined by gel permeation chromatography in dimethylacetamide as solvent versus narrowly distributed polymethyl methacrylate as standard.

The viscosity number (reduced viscosity, VN) correlates with the molecular weight of the polymer and can be measured based on ISO 1628-5 (1998) in a 1 wt.-% polymer solution in N-methylpyrrolidone. Thereby, the elution time (t) of a defined volume of the polymer solution in an Ubbelohde 1C-capillary is related to the running time of the pure solvent (to) and normalized afterwards with the polymer concentration (c in g/ml) according to equation (2):

$$VN = ( \frac{t}{{t}_{0}} * - 1 ) \times \frac{1}{c} \qquad ( 2 )$$

The viscosity number is given in ml/g. The preferred poly(arylene ether nitrile) polymer (P) show viscosity numbers between 100 to 300 ml/g, preferably from 150 to 250 ml/g based on ISO 1628-5 (1998) in a 1 wt.-% polymer solution in N-methylpyrrolidone.

The present invention is directed to a membrane comprising a poly(arylene ether nitrile) polymer (P) as described and preferably described above.

In the context of the present invention, the term “membrane” means a semipermeable structure capable of separating two fluids or separating molecular and/or ionic components or particles from a liquid. Thus, a membrane acts as a selective barrier, allowing some particles, substances or chemicals to pass through, while retaining others.

The membrane may have various geometries such as flat sheet, spiral wound, pillows, tubular, single bore hollow fiber or multiple bore hollow fiber.

The membrane (M) comprises preferably at least 50% by weight of the poly(arylene ether nitrile) polymer (P), more preferably at least 70% by weight and most preferably at least 90% by weight of the poly(arylene ether nitrile) polymer (P) based on the total weight of the membrane (M). Preferably, the membrane (M) comprises from 15 to 80% by weight, more preferably from 20 to 75% by weight, of the poly(arylene ether nitrile) polymer (P) based on the total, weight of the membrane (M).

In a further preferred embodiment, the membrane (M) consists essentially of the poly(arylene ether nitrile) polymer (P).

“Consisting essentially of” means that the membrane (M) comprises more than 93% by weight, preferably more than 95% by weight and most preferably more than 97% by weight of the poly(arylene ether nitrile) polymer (P) based on the total weight of the membrane (M).

According to the invention, the membrane preferably has a molecular weight cut-off of 100 kD or below, in particular from 10 to 100 kDa. The inventive membrane preferably has a pore size of 0.5 nm to 50 nm, preferably 1 to 40 nm, more preferably 5 to 30 nm. Particularly, the pore size may be 5 to 30 nm or 10 to 20 nm.

The membrane (M) according to the present invention preferably has a pure water permeation of >50 kg/(h m² bar), determined using a pressure cell with a diameter of 74 mm using ultrapure water (salt-free water, filtered by a Millipore UF-system) at 23° C. and 1 bar water pressure. The pure water permeation (PWP) is calculated as follows (equation (1)):

$$P W P = \frac{m}{A \times P \times t} \qquad ( 1 )$$

PWP: pure water permeation [kg/bar h m²]
m: mass of permeated water [kg]
A: membrane area [m²]
P: pressure [bar]
t: time of the permeation experiment [h].

A further object of the present invention is a membrane (M), wherein the membrane (M) has a pure water permeation of >50 kg/h m² bar, preferably >100 kg/h m² bar.

A further object of the present invention is therefore a membrane (M), wherein the poly(arylene ether nitrile) polymer (P) has a number-average molecular weight (M_{N}) of from 10 000 to 40 000 g/mol.

The membranes comprising poly(arylene ether nitrile) polymer (P) according to the invention may be suitable for pressure-driven membrane technologies, such as microfiltration, ultrafiltration and nanofiltration. According to one embodiment, the inventive membrane is for microfiltration. According to a further embodiment, the inventive membrane is for nanofiltration. According to a preferred embodiment, the inventive membrane is for ultrafiltration.

According to a specific embodiment, the inventive membrane is an ultrafiltration membrane, comprising an active filtration layer possessing a molecular weight cut-off of 100 kD or below, in particular from 10 to 100 kDa. The inventive ultrafiltration membrane preferably has a pore size of 5 to 30 nm or 10 to 20 nm.

In one embodiment, the inventive membranes comprising the poly(arylene ether nitrile) polymer (P) have flat sheet configuration, wherein the membranes are preferably ultrafiltration membranes. In another embodiment of the invention, the membranes comprising the poly(arylene ether nitrile) polymer (P) have hollow fiber configuration, wherein the membranes are preferably ultrafiltration membranes.

In yet another embodiment of the invention, the membranes comprising the poly(arylene ether nitrile) polymer (P) are present as spiral wound membranes or as pillows. In particular, these membranes are ultrafiltration membranes. In still another embodiment of the invention, the membranes comprising the poly(arylene ether nitrile) polymer (P) are present as tubular membranes, wherein these membranes are preferably ultrafiltration membranes. In still another embodiment of the invention, the membranes comprising the poly(arylene ether nitrile) polymer (P) are present as capillaries, wherein the membrane is preferably an ultrafiltration membrane.

In yet another embodiment of the invention, the membranes comprising the poly(arylene ether nitrile) polymer (P) are present as single bore hollow fiber membranes, preferably ultrafiltration. In yet another embodiment of the invention, the membranes, preferably ultrafiltration membranes, comprising the poly(arylene ether nitrile) polymer (P) are present as multi bore hollow fiber membranes.

According to one inventive embodiment, membranes, such as ultrafiltration membranes according to the invention are used for the pretreatment of sea water or brackish water. In one further embodiment of the invention, the membranes, particularly ultrafiltration membranes, are used for the pretreatment in desalination of sea water or brackish water.

Membranes according to the invention, can be used for the pretreatment in desalination of water with a particularly high salt content of for example 3 to 8% by weight. For example, membranes according to the invention are suitable for the pretreatment in desalination of water from mining and oil/gas production and fracking processes, to obtain a higher yield in these applications. Different types of membrane according to the invention can also be used together in hybrid systems.

In another preferred embodiment membranes according to the invention, particularly ultrafiltration membranes are used for the treatment of industrial or municipal waste water.

Membranes according to the invention, particularly ultrafiltration membranes, can be used in food processing, for example for concentrating, desalting or dewatering food liquids (such as fruit juices), for the production of whey protein powders and for the concentration of milk. Membranes according to the invention, particularly ultrafiltration membranes, can be used in medical applications like in dialysis and other blood treatments, food processing, concentration for making cheese, processing of proteins, desalting and solvent-exchange of proteins, fractionation of proteins, clarification of fruit juice, recovery of vaccines and antibiotics from fermentation broth, laboratory grade water purification, drinking water disinfection (including removal of viruses), removal of endocrines and pesticides combined with suspended activated carbon pretreatment.

Membranes according to the invention, particularly ultrafiltration membranes, can also be used for rehabilitation of mines, homogeneous catalyst recovery, desalting reaction processes. Membranes according to the invention, particularly ultrafiltration membranes, can also be used for separating divalent ions or heavy and/or radioactive metal ions, for example in mining applications, homogeneous catalyst recovery, desalting reaction processes.

In particular, the membranes of the present invention are membranes for water treatment, particularly for drinking water purification. Membranes for water treatment are usually semipermeable membranes which allow for separation of dissolved and suspended particles, macromolecules, colloids and viruses from water, with the separation process itself being able to be driven by pressure or electrically. Upon applying a driving force of for example 1-3 bar, the membrane results in the retention of macromolecules and colloids.

One object of the invention relates to the use of the inventive membranes for drinking water purification, treatment of industrial or municipal waste-water, in the desalination of sea or brackish water, the purification of pharmaceutical products, plasmolysis and food processing.

The preparation of membranes in general is known to the skilled person. General production routes are known from the literature and are described, for example, by M. C. Porter et al. in Handbook of Industrial Membrane Technology (William Andrew Publishing/Noyes, 1990).

According to one object of the present invention, the membrane (M) is prepared by a method comprising the steps:
a) providing a solution(S) which comprises the poly(arylene ether nitrile) polymer (P), at least one pore forming additive (C) and at least one solvent (D), and
b) separating the at least one pore forming additive (C) and the at least one solvent (D) from the solution(S) to obtain the membrane (M).

In step a), the poly(arylene ether nitrile) polymer (P) is the polymer (P) as defined and preferably defined herein.

“At least one pore forming additive” within the context of the present invention means precisely one pore forming additive, and also a mixture of two or more pore forming additives. “At least one solvent” within the context of the present invention means precisely one solvent, and also a mixture of two or more solvents.

The solution(S) in step a) can be provided by any method known to the skilled person. For example, the solution(S) can be provided in step a) in customary vessels that may comprise a stirring device and preferably a temperature control device. Preferably, the solution(S) is provided by dissolving the poly(arylene ether nitrile) polymer (P) and the at least one pore forming additive (C) in the at least one solvent (D).

The dissolution of the poly(arylene ether nitrile) polymer (P) and the at least one pore forming additive (C) in the at least one solvent (D) to provide the solution(S) is preferably effected under agitation.

Step a) is preferably carried out at elevated temperatures, especially in the range from 20 to 100° C., more preferably in the range from 40 to 80° C. A person skilled in the art will choose the temperature in accordance with the at least one solvent (D).

The solution(S) preferably comprises the poly(arylene ether nitrile) polymer (P) and the at least one pore forming additive (C) completely dissolved in the at least one solvent (D). This means that the solution(S) preferably comprises no solid particles of the poly(arylene ether nitrile) polymer (P) and the at least one pore forming additive (C). Therefore, the poly(arylene ether nitrile) polymer (P) and the at least one pore forming additive (C) preferably cannot be separated from the at least one solvent (D) by filtration.

The solution(S) preferably comprises from 1 to 40% by weight of the poly(arylene ether nitrile) polymer (P), from 10 to 20% by weight of the pore forming additive (C) and from 40 to 85% by weight of the at least one solvent (D), each based on the total weight of the solution(S).

Therefore, another object of the present invention is a method for the preparation of a membrane (M), wherein the solution(S) in step a) comprises from 1 to 40% by weight of the poly(arylene ether nitrile) polymer (P), from 10 to 20% by weight of the pore forming additive (C) and from 40 to 85% by weight of the at least one solvent (D), each based on the total weight of the solution(S).

Furthermore, the solution(S) provided in step a) comprises at least one pore forming additive (C) for the membrane preparation. The at least one pore forming additive (C) is preferably selected from the group consisting of water-soluble polymers and alcohols or mixtures thereof, wherein the water-soluble polymers are preferably selected from the group of polyvinylpyrrolidone and poly(alkylene oxides) and mixtures thereof. Consequently, the at least one pore forming additive (C) is selected from the group consisting of polyvinylpyrrolidone, poly (alkylene oxides) and alcohols. In particular, the at least one pore forming additive (C) is selected from poly (alkylene oxides) and polyvinylpyrrolidones. More specifically, the water-soluble polymer is selected from the group of polyvinylpyrrolidone, poly(ethylene oxide), poly(propylene oxide), poly (ethylene oxide)/poly(propylene oxide)-block-copolymers and mixtures thereof.

Preferably, the water-soluble polymers is selected from polyvinylpyrrolidone and poly(alkylene oxides) and mixtures thereof, showing a number average molar mass Mₙ of at least 250 g/mol. More preferably, the water-soluble polymer is selected from the group of polyvinylpyrrolidone, poly (ethylene oxide), poly(propylene oxide), poly(ethylene oxide)/poly(propylene oxide)-block-copolymers and mixtures thereof, showing a Mn of at least 250 g/mol.

Particularly preferably, the water-soluble polymer is selected from the group of polyvinylpyrrolidone and poly(ethylene oxide) s and mixtures thereof, showing a Mn of at least 250 g/mol and, wherein the polyvinylpyrrolidone has a solution viscosity characterized by the K-value of 12 or higher determined according to the method of Fikentscher (described by Fikentscher in Cellulosechemie 13, 1932 (58)). The determination of the K-value by viscosity measurements of polymer solutions as described by Fikentscher is known in the art. A very particularly preferred water-soluble polymer is a polyvinylpyrrolidone with Mn of at least 250 g/mol and a solution viscosity characterized by the K-value of 12 or higher determined according to the method of Fikentscher.

The solution(S) may, for example, comprise the at least one pore forming additive (C) in an amount of from 5 to 25% by weight, preferably in the range of from 10 to 20% by weight, based on the total weight of the solution(S).

The at least one solvent (D) can be any solvent suitable for the poly(arylene ether nitrile) polymer (P) and the at least one pore forming additive (C). Preferably, the at least one solvent (D) is soluble in water. Therefore, the at least one solvent (D) is preferably selected from the group consisting of N-alkyl-2-pyrrolidone, such as N-methyl-2-pyrrolidone, N-ethyl-2-pyrrolidone, N-butyl-2-pyrrolidone and N-tert.-butyl-2-pyrrolidone, 2-pyrrolidone, N,N-dimethylacetamide, dimethylsulfoxide, dimethylformamide, N, N-dimethyl-2-hydroxypropane amide, N,N-diethyl-2-hydroxypropane amide, y-valerolactone, dihydrolevoglucosenone, methyl 5-(dimethylamino)-2-methyl-5-oxopentanoate and sulfolane, wherein N-alkyl-2-pyrrolidone, γ-valerolactone and N,N-dimethyl-2-hydroxypropan amide are particularly preferred. N-methylpyrrolidone is most preferred as the at least one solvent (D).

Another object of the present invention is therefore a method for the preparation of a membrane (M), wherein the at least one solvent (D) is selected from the group consisting of N-alkyl-2-pyrrolidone, preferably N-methyl-2-pyrrolidone, N-ethyl-2-pyrrolidone, N-butyl-2-pyrrolidone and N-tert.-butyl-2-pyrrolidone, 2-pyrrolidone, N,N-dimethylacetamide, dimethylsulfoxide, dimethylformamide, N,N-dimethyl-2-hydroxypropan amide, N,N-diethyl-2-hydroxypropan amide, γ-valerolactone, dihydrolevoglucosenone, methyl 5-(dimethylamino)-2-methyl-5-oxopentanoate and sulfolane.

The solution(S) preferably comprises in the range of from 40 to 85% by weight of the at least one solvent (D), more preferably in the range of from 50 to 70% by weight of the at least one solvent (D), based on the total weight of the solution(S).

In a typical embodiment, the percentages by weight of the poly(arylene ether nitrile) polymer (P), the at least one pore forming additive (C) and the at least one solvent (D) comprised in the solution(S) add up to 100% by weight.

A further object of the present invention is a solution of at least one poly(arylene ether nitrile) polymer (P) as described above in at least one solvent (D) selected from the group consisting of N-alkyl-2-pyrrolidone, 2-pyrrolidone, N,N-dimethylacetamide, dimethylsulfoxide, dimethylformamide, N,N-dimethyl-2-hydroxypropane amide, N,N-diethyl-2-hydroxypropane amide, y-valerolactone, dihydrolevoglucosenone, methyl 5-(dimethylamino)-2-methyl-5-oxopentanoate and sulfolane. N-alkyl-2-pyrrolidone, γ-valerolactone and N,N-dimethyl-2-hydroxypropan amide are particularly preferred. N-alkyl-2-pyrrolidone is preferably selected from N-methyl-2-pyrrolidone, N-ethyl-2-pyrrolidone, N-butyl-2-pyrrolidone and N-tert.-butyl-2-pyrrolidone. The solution preferably comprises in the range of from 40 to 85% by weight of the at least one solvent (D), more preferably in the range of from 50 to 70% by weight of the at least one solvent (D), based on the total weight of the solution(S).

Still a further object is the solution(S) as described above.

The duration of step a) may vary between wide limits. The duration of step a) is preferably in the range of from 10 min to 48 h (hours), especially in the range of from 10 min to 24 h, and more preferably in the range of from 15 min to 12 h. A person skilled in the art will choose the duration of step a) so as to obtain a homogeneous solution of the poly(arylene ether nitrile) polymer (P) and the at least one pore forming additive (C) in the at least one solvent (D).

In step b), the at least one pore forming additive (C) and the at least one solvent (D) are separated from the solution(S) to obtain the membrane (M).

It is possible to filter the solution(S) provided in step a) before the at least one pore forming additive (C) and the at least one solvent (D) are separated from the solution(S) in step b) to obtain a filtered solution (fS). The following embodiments and preferences for separating the at least one pore forming additive (C) and the at least one solvent (D) from the solution(S) apply equally for separating the at least one pore forming additive (C) and the at least one solvent (D) from the filtered solution (fS).

Moreover, it is possible to degas the solution(S) in step a) before the at least one pore forming additive (C) and the at least one solvent (D) are separated from the solution(S) in step b) to obtain a degassed solution (dS). This embodiment is preferred. The following embodiments and preferences for separating the at least one pore forming additive (C) and the at least one solvent (D) from the solution(S) apply equally for separating the at least one pore forming additive (C) and the at least one solvent (D) from the degassed solution (dS).

The degassing of the solution(S) in step a) can be carried out by any method known to the skilled person, for example, via vacuum or by allowing the solution(S) to rest.

The separation of the at least one pore forming additive (C) and the at least one solvent (D) from the solution(S) can be performed by any method known to the skilled person which is suitable to separate pore forming additives and solvents from polymers.

Preferably, the separation of the at least one pore forming additive (C) and the at least one solvent (D) from the solution(S) is carried out via a phase inversion process.

Another object of the present invention is therefore also a method for the preparation of a membrane (M), wherein the separation of the at least one pore forming additive (C) and the at least one solvent (D) in step b) is carried out via a phase inversion process.

If the separation of the at least one pore forming additive (C) and the at least one solvent (D) is carried out via a phase inversion process, the obtained membrane (M) is typically a porous membrane.

A further object of the present invention is a membrane (M), wherein the membrane (M) is a porous membrane (M).

As a person skilled in the art knows, the porous membrane (M) typically has a top layer and a supporting structure at the bottom, wherein the top layer is the active filtration layer. The top layer, as well as the supporting structure typically comprise pores, wherein the pore size distribution of the top layer is decisive for the properties of the membrane. In general, the pore size of the top layer is smaller than the pore size of the supporting structure at the bottom.

Preferably, the pore size of the membrane (M) increases from the top layer, which is used for separation, to the bottom of the membrane (M). Therefore, such a membrane (M) is also called an asymmetric membrane (M).

A further object of the present invention is a membrane (M), wherein the membrane (M) is asymmetric. A further object of the present invention is a membrane (M), wherein the membrane (M) is asymmetric having the smallest pores in the nm range, such as 5 to 30 nm, in the filtration layer which is located opposite to the non-filtration layer having larger pores in the μm range, such as 0.1 to 10 μm.

A phase inversion process within the context of the present invention means a process wherein the dissolved poly(arylene ether nitrile) polymer (P) is transformed into a solid phase. Therefore, a phase inversion process can also be denoted as precipitation process. According to step b), the transformation is performed by separation of the at least one pore forming additive (C) and the at least one solvent (D) from the poly(arylene ether nitrile) polymer (P). The person skilled in the art knows suitable phase inversion processes.

The phase inversion process can, for example, be performed by cooling down the solution(S). During this cooling down, the poly(arylene ether nitrile) polymer (P) is comprised in the solution(S) precipitate. Another possibility to perform the phase inversion process is to bring the solution(S) in contact with a vapour that is a non-solvent for the poly(arylene ether nitrile) polymer (P). The poly(arylene ether nitrile) polymer (P) will then as well precipitate. Suitable vapours, that are non-solvents for the poly(arylene ether nitrile) polymer (P) are, for example, protic polar solvents described hereinafter in their gaseous state. Another phase inversion process, which is preferred within the context of the present invention, is the phase inversion by bringing the solution(S) into contact with a liquid that is a non-solvent for the poly(arylene ether nitrile) polymer (P). Suitable solvents, that are non-solvents for the poly(arylene ether nitrile) polymer (P) are, for example, at least one protic polar solvent described hereinafter in their liquid state.

Therefore, in one embodiment of the present invention, in step b), the at least one pore forming additive (C) and the at least one solvent (D) comprised in the solution(S) are separated from the poly(arylene ether nitrile) polymer (P) comprised in the solution(S) by immersing the solution(S) into at least one protic polar solvent.

This means that the membrane (M) is formed by immersing the solution(S) into at least one protic polar solvent.

Suitable at least one protic polar solvents are known to the skilled person. The at least one protic polar solvent is preferably a non-solvent for the poly(arylene ether nitrile) polymer (P).

Preferred at least one protic polar solvents are water, methanol, ethanol, n-propanol, iso-propanol, glycerol, ethyleneglycol and mixtures thereof. Preferably, the at least one protic polar solvent is water.

Therefore, another object of the present invention is a method for the preparation of a membrane (M), wherein the at least one protic polar solvent is water.

The at least one protic polar solvent is usually comprised in a coagulation bath. The coagulation bath preferably also comprises further components, for example, the same solvent (D) as comprised in the solution(S).

Step b) usually comprises providing the solution(S) in a form that corresponds to the form of the membrane (M), which is obtained in step b).

Therefore, in one embodiment of the present invention, step b) comprises casting of the solution (S) to obtain a film of the solution(S).

Therefore, in one preferred embodiment of the present invention, step b) comprises the following steps:
b-1) casting the solution(S) provided in step a) to obtain a film of the solution(S),
b-2) immersing the film of the solution(S) into at least one protic polar solvent, wherein the poly(arylene ether nitrile) polymer (P) comprised in the film of the solution(S) is at least partly separated from the at least one pore forming additive (C) and the at least one solvent (D) comprised in the film of the solution(S) to obtain a membrane (M1) which is in the form of a film, and
b-3) washing the membrane (M1) with water, wherein the poly(arylene ether nitrile) polymer (P). comprised in the membrane (M1) are completely separated from the at least one pore forming additive (C) and the at least one solvent (D) comprised in the membrane (M1) to obtain the membrane (M).

The term “at least partly” within the context of the present invention means that preferably at least 50% by weight, more preferably at least 60% by weight, of the poly(arylene ether nitrile) polymer (P) based on the total weight of the poly(arylene ether nitrile) polymer (P) comprised in the film of the solution(S), are separated from the at least one pore forming additive (C) and the at least one solvent (D).

The term “completely” within the context of the present invention means that preferably at least 90% by weight, more preferably at least 95% by weight, of the poly(arylene ether nitrile) polymer (P), based on the total weight of the poly(arylene ether nitrile) polymer (P) comprised in the membrane (M1), are separated from the at least one pore forming additive (C) and the at least one solvent (D).

In step b-1) the solution(S) can be cast by any method known to the skilled person. Usually, the solution(S) is cast with a casting knife that is heated to a temperature in the range from 20 to 100° C., preferably in the range from 40 to 80° C.

Therefore, another object of the present invention is a method for the preparation of a membrane (M), wherein step b-1) is carried out at a temperature in the range of 40 to 80° C.

The solution(S) is usually cast on a substrate that does not react with the poly(arylene ether nitrile) polymer (P), the at least one pore forming additive (C) or the at least one solvent (D) comprised in the solution(S).

Suitable substrates are known to the skilled person and are, for example, selected from glass plates and polymer fabrics such as non-woven materials.

To obtain a dense membrane, the separation in step b) is typically carried out by evaporation of the at least one solvent (D) comprised in the solution(S).

In step b-2), the film of the solution(S) is preferably immersed into at least one protic polar solvent at a temperature in the range of 20 to 80° C., more preferably at a temperature in the range of 20 to 60° C.

In step b-3), the membrane (M1) is preferably washed at a temperature in the range of 20 to 80° C., more preferably at a temperature in the range of 20 to 60° C.

The membrane (M) obtained in step b-3) is preferably a flat sheet membrane.

The membrane (M) can be used as ultra, nano and microfiltration membrane.

A further object of the present invention is therefore also the use of the membrane (M) as ultrafiltration membrane.

For the production of single bore hollow fibers or multiple bore hollow fibers step b) may be performed by extruding the solution(S) through an extrusion nozzle with the required number of hollow needles. The coagulating liquid is then injected through the hollow needles into the extruded polymer during extrusion, so that parallel continuous channels extending in extrusion direction are formed in the extruded polymer. Preferably, the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent.

The present invention furthermore relates to an apparatus, system or device selected from a filtration element, membrane module and filtration system, comprising an inventive membrane as described herein.

A further object of the invention is a method for the purification of water, wherein the water is passed through a membrane to remove particles, colloids, macromolecules, bacteria and/or viruses and wherein the filtration membrane is regularly subjected to CIP cleaning cycles in order to restore the filtration capacity-

A further object of the invention is a method for the cleaning of an inventive membrane as described herein, comprising the use of oxidative chemicals such as bleach, chlorine and/or hypochlorite.

The membranes of the present invention exhibit excellent mechanical properties, thermal stability and chemical resistance. The inventive membranes are astonishingly stable are show comparably high resistance against common membrane cleaning treatment such as cleaning with oxidative chemicals, e.g. NaOCl. Compared to membranes of the state of the art, the inventive membranes can undergo several cleaning cycles while the membrane performance can substantially be maintained. Consequently, the inventive membranes can advantageously be used in applications where cleaning steps are necessary to remove fouling and other residues from the membranes and, thus, can be re-used several times.

The present invention is more particularly elucidated by the following examples without being restricted thereto.

### EXAMPLES

Abbreviations and compounds used in the examples:
PVP polyvinylpyrrolidone
DSC differential scanning calorimetry
GPC gel permeation chromatography
MWCO molecular weight cut-off
NMP N-methyl-2-pyrrolidone
NTU nephelometric turbidity unit
PWP pure water permeation
26DBCN 2,6-dichlorbenzonitrile [CAS 1194-65-6] Fa. Alzchem Group AG, Trostberg, Germany
HC hydrochinone [CAS 123-31-9] Fa. Sigma-Aldrich Chemie GmbH, Taufkirchen, Germany
DHBP 4,4′-dihydroxybiphenyl [CAS 92-88-6]
1HNMR Proton nuclear magnetic resonance spectroscopy
Ultrason® E 6020 P Polyethersulfone with a viscosity number (measured based on ISO 1628-5 (1998) in a 1 wt.-% polymer solution in N-methylpyrrolidone) of 81 ml/g; a glass transition temperature (DSC, 10 K/min; according to ISO 11357-1 (2017) and 11357-2 (2020)) of 225° C.; a molecular weight M_{w} (GPC in THF, PS standard) of 75000 g/mol, and M_{w}/Mₙ=3, which is abbreviated as “E6020P”
Luvitec® K90 Polyvinylpyrrolidone with a molecular weight M_{w} of 1000000 to 1500000 g/mol and a solution viscosity characterized by the K-value of 90, determined according to the method of Fikentscher (Fikentscher, Cellulosechemie 13, 1932 (58)), which is abbreviated as “K90”

### A) Synthesis of poly(arylene ether nitrile) polymer (P) (VI) from 2,6-dichlorbenzonitrile, dihydroxydiphenyl, hydrochinone [polymer (VI)-A]

In a 4 L vessel equipped a with stirrer, Dean-Stark-trap, nitrogen inlet and temperature control 275.3 g (1.6 mol) of 2,6-dichlorbenzonitrile (26DBCN), 226.73 g (1.218 mol) of dihydroxydiphenyl (DHDP) and 44.04 g (0.40 mol) of hydrochinone (HC) were dissolved, under nitrogen (30 L/h), in 800 ml of N-methylpyrrolidone (NMP) and mixed with 232.19 g (1.68 mol) of anhydrous potassium carbonate at a stirring rate of 130 rpm. The reaction mixture was firstly heated at 180° C., for 1 h at a pressure of 300 mbar, the water of the reaction and N-methylpyrrolidone being continuously distilled off, and then reacted for 0.5 h at 190° C. After adding 800 ml of N-methylpyrrolidone, the mixture was cooled to 80° C. and inorganic constituents were filtered off. Subsequently the polymer was then isolated by precipitation in water. After extraction with water for 20 h at 80° C. (160 L/h water flux), the product was dried under reduced pressure at 140° C., yielding a white powder (poly(arylene ether nitrile) polymer (P), polymer (VI)-A).

The proportion of HC units was determined using 1H-NMR (CDCl₃, 400 MHz) as 24.8+0.9 mol %, the viscosity number (measured based on ISO 1628-5 (1998) in a 1 wt.-% polymer solution in N-methylpyrrolidone) of the product was 191.2 ml/g, with a glass transition temperature (DSC, 20 K/min; according to ISO 11357-1 (2017) and 11357-2 (2020)) of 201° C. and a molecular weight Mw (GPC in DMAc+0.5 wt % LiBr, PMMA standard) of 68700 g/mol, and Mw/Mn=2.2.

### Determination of Solution Turbidity:

The polymer solution turbidity was measured with a turbidimeter 2100AN (Hach Lange GmbH, Düsseldorf, Germany) employing a filter of 860 nm at 60° C. and expressed in nephelometric turbidity units (NTU).

### Determination of Solution Viscosity:

The polymer solution viscosity was measured with a Brookfield Viscometer DV-I Prime (Brookfield Engineering Laboratories, Inc. Middleboro, USA) with RV 6 spindle at 60° C. with 5-100 rpm. The utilized shear rate is dependent on the solution viscosity and is given in the tables below.

### Determination of the Membrane Water Permeability:

$$equation ( 1 ) )$$

$$P W P = \frac{m}{A \times P \times t} \qquad ( 1 )$$

PWP: pure water permeation [kg/bar h m²]
m: mass of permeated water [kg]
A: membrane area [m²]
P: pressure [bar]
t: time of the permeation experiment [h].

### Determination of the Membrane's MWCO:

In a subsequent test, an aqueous solution of poly(ethylene oxide)-standards (2, 3, 4, 6, 8, 10, 12, 20 and 100 KDa with 9.77, 14.77, 17.45, 25.59, 29.08, 34.90, 30.83, 23.37 and 814.33 ppm) with increasing molecular weight were used as feed to be filtered by the membrane at a pressure of 0.15 bar. By GPC-measurement of the feed and permeate, the molecular weight of the permeate of each poly(ethylene oxide)-standard used was determined.

### Determination of the Membrane's Mechanical Stability:

Tensile testing was carried out according DIN Iso 527-3 using specimen according DIN 53504-S3A and the wet membranes characterized regarding strain at break (strain in %) in order to assess the stability against oxidative conditions.

### B) Preparation of Membranes—General Procedure

The amounts given in this general procedure are general ranges, the exact amount for the respective experiment can be found in table 1. A clear viscous solution, usually referred to as solution of 15-19 g membrane polymer and 5-6 g Luvitec® polyvinylpyrrolidone K90 in 75-80 g NMP was prepared using a SpeedMixer® DAC 600.1 Vac-P (Hauschild & Co. KG, Hamm, Germany) at speeds of 200, 800 and 1200 rpm within 30 minutes of mixing. The solution was degassed overnight at room temperature.

After that, the membrane solution was reheated at 60° C. for 2 hours and casted onto a glass plate with a casting knife (300 microns) at 60° C. using an Erichsen Coating machine (Coatmaster 510, Erichsen GmbH & Co KG, Hemer, Germany) operating at a speed of 5 mm/s. The membrane film was allowed to rest for 30 seconds before immersion at 25° C. for 10 minutes in a water-based coagulation bath consisting of a mixture of the same solvent used for the preparation of the above-mentioned polymer solution and water at a ratio of 50:50 based on weight. After the membrane had detached from the glass plate, the membrane was exposed to a water bath containing a 2000 ppm NaOCl solution at 60° C. and a pH of 9.5 for 2 h. The membrane was then washed with water at 60° C. and one time with a 0.5 wt.-% solution of sodium bisulfite to remove active chlorine. After the posttreatment the membranes are stored in a wet state.

TABLE 1
Compositions of poly(arylene ether nitrile)
polymer (P) (VI)-A and Ultrason ®
E 6020 P solutions prepared with PVP in NMP.

| | Ultrason | | | |
|---|---|---|---|---|
| | E6020P | polymer (VI)-A | K90 | NMP |
| Solution S-1 | — | 15 g | 5 g | 80 g |
| Solution S-2 | 19 g | — | 6 g | 75 g |

TABLE 2
Properties of poly(arylene ether nitrile) polymer (P) (VI)-A
and Ultrason ® E 6020 P membranes prepared from solutions
according to Table 1; coagulation water-NMP (40/60 wt/wt)
and post treatment in NaOCl (2000 ppm, pH 9.5, 60° C., 2 h)

| | Visco | | | | |
|---|---|---|---|---|---|
| | [Pas*s] | Turbidity | Thickness | PWP | MWCO |
| | (rpm) | [NTU] | [μm] | [kg/h m²bar] | [kDa] |
| membrane M-1 | 26.9 | 0.641 | 145 | 945 | 33.6 |
| from S-1 | (20) | | | | |
| membrane M-2 | 15.25 | 0.738 | 155 | 910 | 88.0 |
| from S-2 | (20) | | | | |

TABLE 3
Membrane stability after oxidative treatment with NaOCl (2000 ppm,
pH 8, room temperature), elongation at break (ε, %) from tensile testing.
$Elongation at break retention = \frac{ε ( t = x )}{ε ( t = 0 )} \times 100 [ \% ]$

| | | | | Elongation at |
|---|---|---|---|---|
| | | time at | Elongation at | break retention |
| Exp. | polymer | NaOCl [h] | break [%] | [%] |
| M1-a | (VI)-A | 0 | 28.5 ± 2 | — |
| M1-b | (VI)-A | 24 | 28.3 ± 1 | 99.3 |
| M1-c | (VI)-A | 48 | 22.7 ± 2 | 79.7 |
| M1-d | (VI)-A | 72 | 20.3 ± 1 | 71.2 |
| M2-a | Ultrason | 0 | 47.1 ± 2 | — |
| | E6020P | | | |
| M2-b | Ultrason | 24 | 38.8 ± 3 | 82.4 |
| | E6020P | | | |
| M2-c | Ultrason | 48 | 11.5 ± 2 | 24.4 |
| | E6020P | | | |
| M2-d | Ultrason | 72 | 10.3 ± 3 | 21.9 |
| | E6020P | | | |

The inventive membranes made from the poly(arylene ether nitrile) polymers (P) show superior stability against oxidation by NaOCl as can be seen from a lower reduction to 71% of elongation at break compared to non-treated samples (t=0 h) upon treatment for 72 h compared to polyethersulfone based membranes with a reduction to 22% of elongation at break compared to non-treated samples (t=0 h) representing the state of the art.

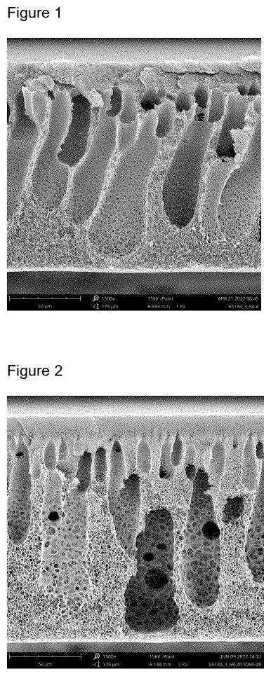

Scanning electron microscopy (SEM) of cryo-broken membrane cross-sections reveal identical membrane morphologies for M-1 and M-2. Both membranes have a nano-porous filtration layer on the top of 10-15 μm thickness which are supported by spongy-type substructure with increasing pore size towards the bottom.
FIG. 1: SEM cross-sections (magnification 1500×) of membrane M-1 from S-1
FIG. 2: SEM cross-sections (magnification 1500×) of membrane M-2 from S-2

1.-16. (canceled)

17. A membrane (M) comprising a poly(arylene ether nitrile) polymer (P) having structural units of Formulae (I) and (II); (I) and (III), or (I), (II) and (III): 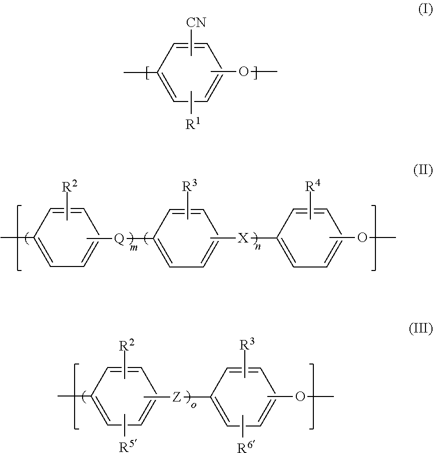
wherein
Q is a direct bond or O;
X is a direct bond or O;
Z is a direct bond or O;
R¹, R², R³, R⁴, R⁵, R^{5′}, R⁶ and R^{6′} are independently selected from H, halogen, nitro and OR, wherein R is selected from C₁-C₆ alkyl and C₆-C₁₂ aryl; and
m, n and o are independently selected from 0 or 1.

18. The membrane of claim 17, wherein in Formula (II) m is 0 and n is 1, corresponding to sub-Formula (II-4)

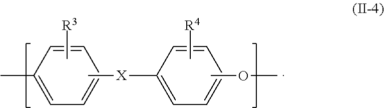

19. The membrane of claim 18, wherein Formula (II) corresponds to sub-Formula (II-6)

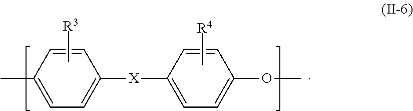

20. The membrane of claim 19, wherein X is a direct bond and R³ and R⁴ are H.

21. The membrane of claim 17, wherein in Formula (III) o is 0 and R⁵, R^{5′} and R^{6′} are H, corresponding to sub-Formula (III-3)

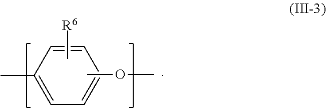

22. The membrane of claim 21, wherein the oxy bond is in para position to the chemical bond connecting to the adjacent structural unit, and R⁶ is H.

23. The membrane of claim 17, comprising a poly(arylene ether nitrile) polymer (P) having structural units of Formulae (I) and (II).

24. The membrane of claim 17, comprising a poly(arylene ether nitrile) polymer (P) having structural units of Formulae (I) and (III).

25. The membrane of claim 17, comprising a poly(arylene ether nitrile) polymer (P) having structural units of Formulae (I), (II) and (III).

26. The membrane of claim 17, wherein the poly(arylene ether nitrile) polymer (P) comprises structural units of formula (VI), wherein p=0.05 to 0.95 and q=0.05 to 0.95

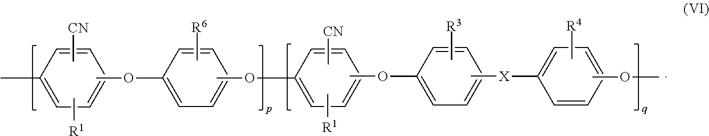

27. The membrane (M) of claim 17, wherein the membrane (M) is asymmetric.

28. The membrane (M) of claim 17 having flat sheet or hollow fiber configuration.

29. Method for preparing the membrane (M) according to claim 17 comprising the steps:
a) providing a solution(S) which comprises the poly(arylene ether nitrile) polymer (P), at least one pore forming additive (C) and at least one solvent (D), and
b) separating the at least one pore forming additive (C) and the at least one solvent (D) from the solution(S) to obtain the membrane (M).

30. A method comprising providing the membrane (M) according to claim 17 and utilising the membrane for drinking water purification, treatment of industrial or municipal waste water, in the desalination of sea or brackish water purification, purification of pharmaceutical products, plasmolysis and food processing.

31. A filtration element, membrane module or filtration system comprising the membrane according to claim 17.

32. A solution of at least one poly(arylene ether nitrile) polymer (P) comprised in the membrane (M) according to claim 17 in at least one solvent selected from the group consisting of N-alkyl-2-pyrrolidone, 2-pyrrolidone, N,N-dimethylacetamide, dimethylsulfoxide, dimethylformamide, N,N-dimethyl-2-hydroxypropane amide, N,N-diethyl-2-hydroxypropane amide, γ-valerolactone, dihydrolevoglucosenone, methyl 5-(dimethylamino)-2-methyl-5-oxopentanoate and sulfolane.
